(19) United States
(12) Patent Application Publication
(10) Pub. No.: US 2025/0178391 A1
(43) Pub. Date: Jun. 5, 2025

(54) MOTOR VEHICLE INCLUDING A TRAILER HITCH DEVICE

(71) Applicant: BOS GmbH & Co. KG, Ostfildern (DE)

(72) Inventors: Thomas FISCHER, Tübingen (DE); Christian SCHRECK, Ostfildern (DE)

(21) Appl. No.: 18/950,580

(22) Filed: Nov. 18, 2024

Related U.S. Application Data
(60) Provisional application No. 63/604,368, filed on Nov. 30, 2023.

(51) Int. Cl. B60D 1/60; B60D 1/06; B60D 1/52

(52) U.S. Cl. CPC B60D 1/60; B60D 1/06; B60D 1/52

(57) ABSTRACT

Motor vehicle including a trailer hitch device with a rear receptacle fixed to the vehicle and a carrier section for a hitch ball of a trailer coupling. The carrier section is detachably fastenable to the rear receptacle. The trailer hitch device additionally includes a locking element for securing the carrier section to the receptacle. On the vehicle side, a cover apparatus is provided for covering or exposing the receptacle depending on a fastening of the carrier section, which fastening includes a cover element mounted so as to be movable on the vehicle side between a closed position and an exposing position. A drive apparatus is also provided, and is connected to the cover element for shifting the cover element.

### CROSS-REFERENCE TO RELATED APPLICATION

This claims priority from U.S. Provisional Application No. 63/604 368, filed Nov. 30, 2023, the disclosure of which is hereby incorporated by reference in its entirety.

### TECHNICAL FIELD

The invention relates to a motor vehicle comprising a trailer hitch device, which comprises a rear receptacle fixed to the vehicle and a carrier section for a hitch ball of a trailer coupling, the carrier section being provided for being detachably fastened to the receptacle, and comprising a locking element for securing the carrier section to the receptacle.

### BACKGROUND AND SUMMARY

Motor vehicles of this kind in the form of passenger cars are generally known in the USA. A passenger car of this kind comprises a rectangular tube at the rear as a receptacle, which is welded to a carrier structure of the passenger car or is rigidly connected thereto in another manner. A trailer coupling which has a rectangular carrier section comprising a hitch ball can be inserted into this receptacle. To fix the carrier section positively in the receptacle, the receptacle and the carrier section comprise transversely extending passages, through which a securing bolt can be inserted, which acts as a locking element for the carrier section relative to the receptacle. The carrier section comprising the hitch ball is mounted on or dismounted from the receptacle and the securing bolt is fastened or detached manually by an operator. The receptacle fixed to the vehicle is accessible in the rear region of the passenger car, but is often difficult to reach due to body styling parts.

The problem addressed by the invention is to provide a motor vehicle of the type mentioned at the outset which allows for convenient and secure handling of the trailer hitch device.

This problem is solved in that, on the vehicle side, a cover apparatus is provided for covering or exposing the receptacle depending on a fastening of the carrier section, which fastening comprises a cover element mounted so as to be movable on the vehicle side between a closed position and an exposing position, and comprises a drive apparatus, which is connected to the cover element for shifting the cover element. The carrier section is also called a carrier profile. According to the invention, a cover element is provided on the vehicle side, which is mounted on the rear of the motor vehicle so as to be movable between a closed position covering a rear end face of the carrier section and an exposing position that exposes the open end face of the carrier section. As a result, the cover element is permanently connected to the rear region of the motor vehicle. In the closed position, the cover element prevents the carrier section from getting dirty. In addition, the cover element can form a visually appealing rear enclosure in the region of the carrier section for the motor vehicle and due to the permanent connection, it cannot be lost. An electromotive drive is preferably provided as the drive apparatus. Alternatively, it is also possible to provide a pneumatic or hydraulic drive unit as the drive apparatus in order to shift the cover element. It is also possible to configure the drive apparatus such that an electromotive, pneumatic, or hydraulic drive unit is provided in one shifting direction and a mechanical drive unit, such as a spring drive in particular, is provided in the opposite shifting direction. The electromotive, pneumatic, or hydraulic drive unit can preferably permanently act against the opposite spring force of the spring drive, or the spring drive is activated once an end position of the cover element is reached by means of the electromotive, pneumatic, or hydraulic drive. The electromotive, pneumatic, or hydraulic drive unit is then preferably switched into an idle state, in order to exert no counterforce, or no significant counterforce, on the spring drive acting in the opposite direction.

In one configuration of the invention, a switching arrangement is provided for activating the drive apparatus. The switching arrangement preferably has an electrical configuration. The switching arrangement can be manually operated and can preferably be provided on the vehicle side in a rear region of the motor vehicle in the vicinity of the receptacle. Alternatively, the switching arrangement can be triggered by a vehicle controller.

In another configuration of the invention, a rear bodywork enclosure is provided, which is provided with a cut-out in the region of the receptacle, and the cover element is dimensioned such that the cover element is flush with edges of the cut-out in the closed position. This first of all results in a visually uniform rear enclosure when the cover element is in its closed position. In addition, the cover element extending so as to be flush with the rear bodywork enclosure in its closed position allows for an aerodynamically favorable design for the motor vehicle.

In another configuration of the invention, the drive apparatus comprises a guide arrangement for the cover element, which guide arrangement is provided on the inside of the rear bodywork enclosure in order to make it possible to shift the cover element on the inside along the rear bodywork enclosure out of the closed position in the direction of the exposing position. The guide arrangement is arranged on the inside of the rear bodywork enclosure, preferably a rear vehicle bumper, so as to be invisible to someone looking at the rear of the vehicle. This is both an aerodynamically favorable solution and allows the guide arrangement on the inside to function without getting dirty. In addition, owing to the guide arrangement, the cover element has a defined shifting path, which ensures secure transfer into the end position in question. The guide arrangement is preferably constructed as a linear guide comprising corresponding parallel guide tracks for the cover element.

In another configuration of the invention, the drive apparatus comprises pivoting kinematics, in order to shift the cover element between the closed position and the exposing position. The cover element is permanently connected to the pivoting kinematics. The pivoting kinematics itself is permanently mounted on the vehicle side. The pivoting kinematics is driven by a drive unit of the drive apparatus, as already described.

The problem addressed by the invention is also solved in that the locking element is mounted so as to be movable by means of a guide apparatus between a securing position blocking the carrier section in the receptacle and an open position that exposes the receptacle. As a result, the locking element also permanently remains in the rear region of the motor vehicle. The guide apparatus ensures defined guidance of the locking element between the securing position and the open position.

In one configuration of the invention, a control apparatus is assigned to the locking element in order to shift the locking element between its end positions by means of the guide apparatus. The control apparatus comprises a drive unit, which has an electromotive, pneumatic, hydraulic, or mechanical construction, similarly to the above-described drive unit of the drive apparatus for the cover element. The control apparatus also comprises a control unit, which activates, deactivates, and controls the drive unit. The control unit can be constructed as an electronic control unit.

In another configuration of the invention, a sensor arrangement, which detects the carrier section being mounted on or dismounted from the receptacle, is assigned to the receptacle fixed to the vehicle, and the control apparatus for shifting of the locking element controls the locking element into the securing position or the open position depending on detection signals from the sensor arrangement. This ensures that, after mounting the carrier section, the locking element is forcibly transferred into the securing position.

In another configuration of the invention, the drive apparatus can be operatively connected to the sensor arrangement in order to shift the cover element, and the drive apparatus is coupled to the control apparatus for shifting of the locking element.

In another configuration of the invention, the drive apparatus is coupled to the control apparatus such that the drive apparatus shifts the cover element out of an intermediate position into an end position depending on detection signals from the sensor arrangement, and the drive apparatus of the cover element interacts with the control apparatus of the locking element when being transferred into the end position in order to activate the control apparatus for shifting the locking element out of the open position into the securing position. By means of this configuration, the cover element is initially shifted out of its closed position into an intermediate position, in which the receptacle fixed to the vehicle is exposed for mounting the carrier section. Once the mounted end position of the carrier section is detected, the cover element shifts into its open position. In this case, the drive apparatus of the cover element interacts with the control apparatus of the locking element in order to ensure the locking of the carrier section relative to the receptacle by means of the locking element when shifting the cover element out of the intermediate position into the open position.

In another configuration of the invention, the drive apparatus mechanically interacts with the control apparatus in order to achieve the desired forced coupling of the shifting of the cover element into its open end position while transfering the locking element into its securing position.

The invention also relates to a trailer hitch device for a motor vehicle, comprising a rear receptacle fixed to the vehicle and a carrier section for a hitch ball of a trailer coupling, the carrier section being provided for being detachably fastened to the receptacle, and comprising a locking element for securing the carrier section to the receptacle, wherein, on the vehicle side, a cover apparatus is provided for covering or exposing the receptacle depending on a fastening of the carrier section, which fastening comprises a cover element mounted so as to be movable on the vehicle side between a closed position and an exposing position, and comprises a drive apparatus, which is connected to the cover element for shifting the cover element, and/or wherein the locking element is mounted so as to be movable by means of a guide apparatus between a securing position blocking the carrier section in the receptacle and an open position that exposes the receptacle. This trailer hitch device advantageously has configurations as described above.

Further advantages and features of the invention will become clear from the claims and from the following description of preferred exemplary embodiments of the invention, which are set out with reference to the drawings.

### BRIEF DESCRIPTION OF THE DRAWINGS

FIG. 1 is a schematic plan view from above of a first embodiment of a trailer hitch device on an embodiment of a motor vehicle according to the invention in a closed position of a cover element;

FIGS. 2 to 10 show the embodiment according to FIG. 1 in different functional positions;

FIG. 11 is a schematic side view of another embodiment of a trailer hitch device for an embodiment of a motor vehicle according to the invention with a first functional position;

FIGS. 12 to 16 show the trailer hitch device according to FIG. 11 in further functional positions;

FIG. 17 is a schematic plan view of a portion of the trailer hitch device according to FIGS. 11 to 16; and

FIG. 18 shows a further functional position of the trailer hitch device according to FIGS. 11 to 16.

### DETAILED DESCRIPTION

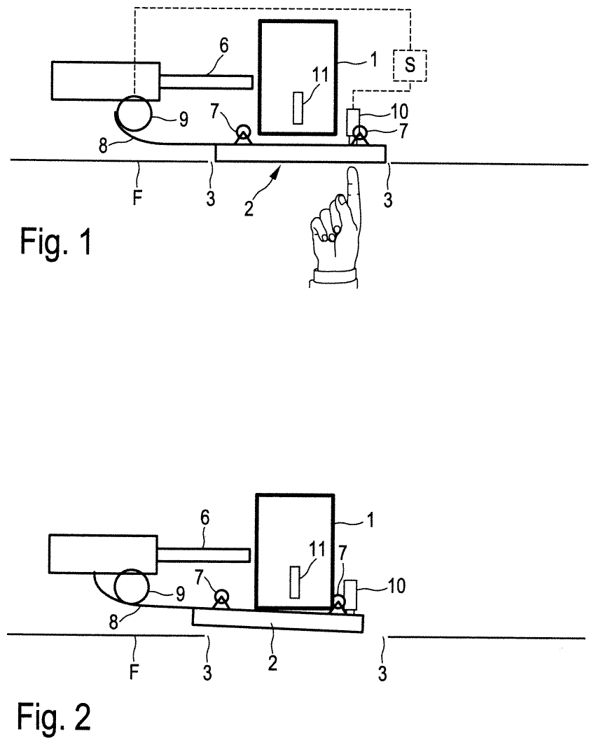

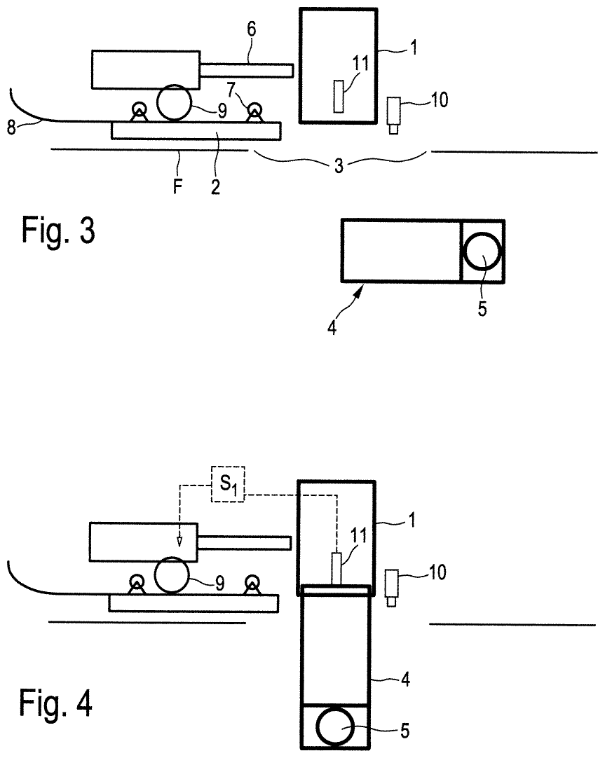

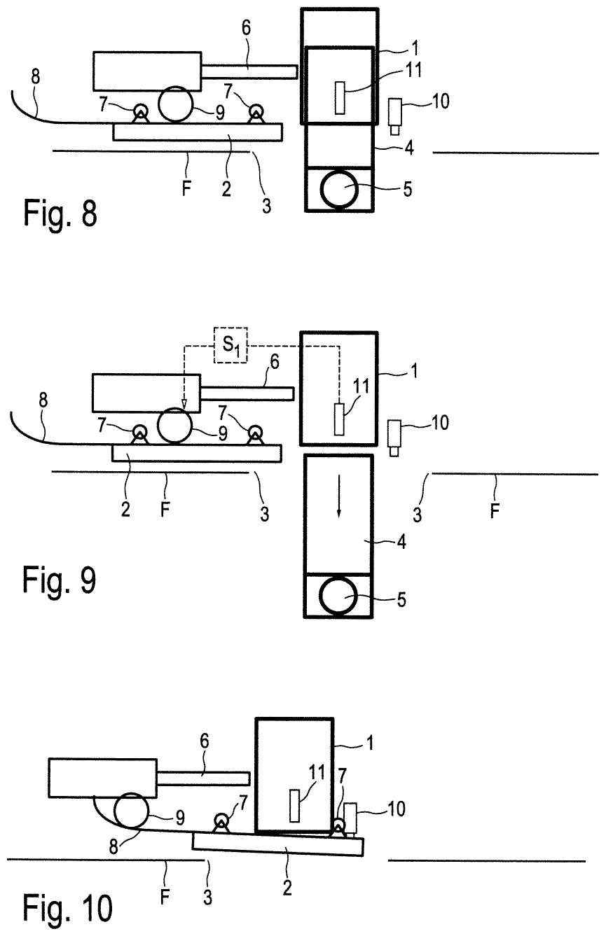

According to FIGS. 1 to 10, in a rear region, a passenger car F comprises a receptacle 1 fixed to the vehicle, which is configured as a rectangular tube, the end face of which is open toward the rear region. The receptacle 1 is connected to a carrier structure of the passenger car F in a crash-resistant manner. The passenger car F comprises, in its rear region, a rear bodywork enclosure, which can be constructed in the form of a rear bumper. The rear bodywork enclosure of the passenger car F is provided with a cut-out 3 at the level of the receptacle 1. The end face of the receptacle 1 is offset forward relative to the cut-out 3 in the longitudinal vehicle direction.

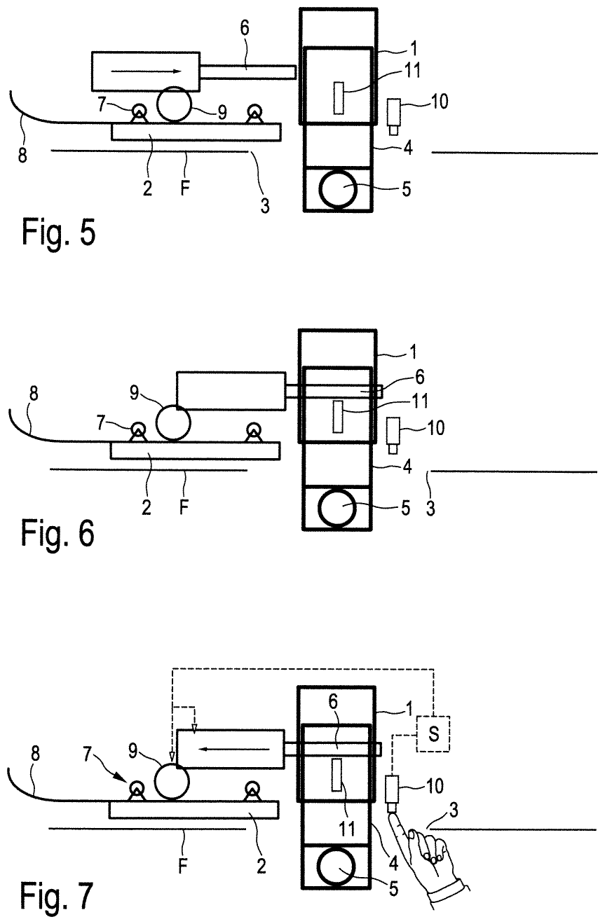

The cut-out 3 can be closed in a flush manner by a cover element 2 in the closed position of the cover element 2, as is apparent from FIG. 1. The cover element 2 is mounted so as to be movable on the vehicle side by means of a guide arrangement 7 (merely indicated) in the form of a linear guide between the closed position according to FIG. 1 and an exposing position according to FIGS. 5 to 9, in which the cover element 2 is shifted to the side in the transverse vehicle direction so as to be covered by the rear bodywork enclosure of the passenger car F, while releasing the open end face of the receptacle 1. To shift the cover element 2 in the guide arrangement 7, a drive apparatus 8, 9 is provided, which comprises a transmission drive train 8 and an electric drive motor 9.

The receptacle 1 serves to fasten a trailer coupling 4, 5, which comprises a carrier section 4 and a hitch ball 5 fastened to the carrier section 4. The carrier section 4 is configured as a rectangular section, the outer contour of which is coordinated with an inner contour of the receptacle 1, in order to allow the carrier section 4 to be slid in or pulled out relative to the receptacle 1.

To fix the carrier section 4 in its state in which it is slid into the receptacle 1 (FIGS. 5 to 7), a locking device 6 is provided, which comprises a locking element in the form of a cylindrical securing bolt and a control apparatus (not denoted in greater detail), which drives the locking element in opposite directions (see arrows in FIGS. 5 and 7). Circular passages, which are aligned with one another in the functional position in which the carrier section 4 is slid into the receptacle 1 in order to allow the locking element to be slid through, are provided both in side walls of the receptacle 1 and in side walls of the carrier section 4. The locking element is linearly movably guided in the transverse vehicle direction by means of the control apparatus.

A switching arrangement 10 is assigned to the receptacle 1, which switching arrangement, when viewed from the rear of the vehicle, is positioned so as to be fixed to the vehicle inside the cut-out 3 behind the cover element 2 in its closed position. The switching arrangement is connected to the drive motor 9 for the cover element 2 by means of a control unit S. The switching arrangement 10 comprises a button, which can be manually operated in order to implement a switching process of the electrical switching arrangement. As a result, the drive motor 9 for the cover element 2 is activated via the control unit S in the closed position of the cover element 2, as a result of which the cover element 2 is shifted into the closed position.

A sensor arrangement 11 which detects whether or not the carrier section 4 is present in the receptacle 1 is provided in the receptacle 1 so as to be fixed to the vehicle. When the carrier section 4 including its hitch ball 5 is thus slid into the receptacle 1 from the rear side, the sensor arrangement 11 detects the functional position in which the carrier section 4 is slid in. The sensor arrangement 11 is coupled to the control apparatus for the locking element via a control unit S₁. The control apparatus comprises a linear drive in order to transfer the locking element into the securing position or the release position. Once the sensor arrangement 11 emits the signal that the carrier section 4 is in its slid-in end position to the control unit S₁, the linear drive for the locking element is activated via the control unit S₁, as a result of which the locking element of the locking device 6 is inserted through the passages into the receptacle 1 and through the carrier section 4 in the transverse vehicle direction. As a result, the carrier section 4 is positively secured in the receptacle 1 in its slid-in end position.

When the carrier section 4 together with its hitch ball 5 is to be removed from the receptacle 1, the switching arrangement 10 is again manually actuated (FIG. 7), as a result of which the control unit S outputs corresponding signals both to the linear drive of the locking device 6 and to the drive motor 9 of the drive apparatus of the cover element 2. The control apparatus of the locking device moves the linear drive for the locking element in order to move the locking element out of the receptacle 1 and thus to transfer the locking element into the release position. The carrier section 4 together with the hitch ball 5 is then pulled rearward out of the receptacle 1 by hand. The sensor arrangement 11 identifies the dismounting of the carrier section 4 and emits a corresponding signal to the control unit S₁. This actuates the drive motor 9 of the cover element 2 in order to transfer the cover element 2 back into its closed position, in which the cover element 2 closes the cut-out 3 in a flush manner.

In the present embodiment, the cover element 2 is shifted in substantially the transverse vehicle direction between its closed position and its open position. In an embodiment of the invention that is not shown, the arrangement and guidance of the cover element can also be provided such that the cover element is shifted in the longitudinal vehicle direction and/or the vertical vehicle direction between the closed position and the open position.

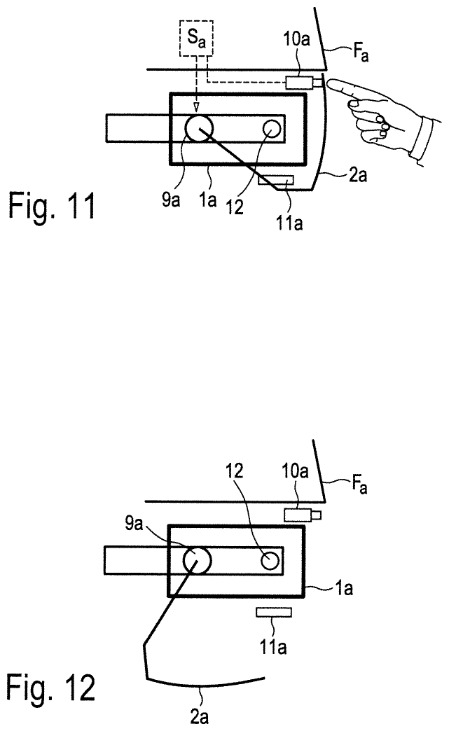

In the embodiment according to FIGS. 11 to 18, functionally identical parts and portions are provided with identical reference signs, with the addition of the letter a. The motor vehicle in the form of a passenger car Fₐ according to FIGS. 11 to 18 likewise comprises, at the rear, similarly to the above-described exemplary embodiment, a receptacle la, which is constructed as a hollow rectangular section and is connected to a carrier structure of the passenger car Fₐ in a crash-resistant manner. The trailer hitch device also comprises a cover element 2a, but it can be shifted between a closed position (FIG. 11) and an intermediate position that exposes the receptacle 1a (FIG. 12) as well as an open end position (FIGS. 16 and 18) in a pivotally movable manner by means of a pivoting mechanism. A pivot drive 9a is provided to shift the cover element 2a between the opposite end positions. In the closed position (FIG. 11), the shell-like cover element 2a is flush with a rear bodywork enclosure of the passenger car Fₐ. In the intermediate position and the open end position, the cover element 2a is pivoted downward in the vertical vehicle direction and forward in the longitudinal vehicle direction.

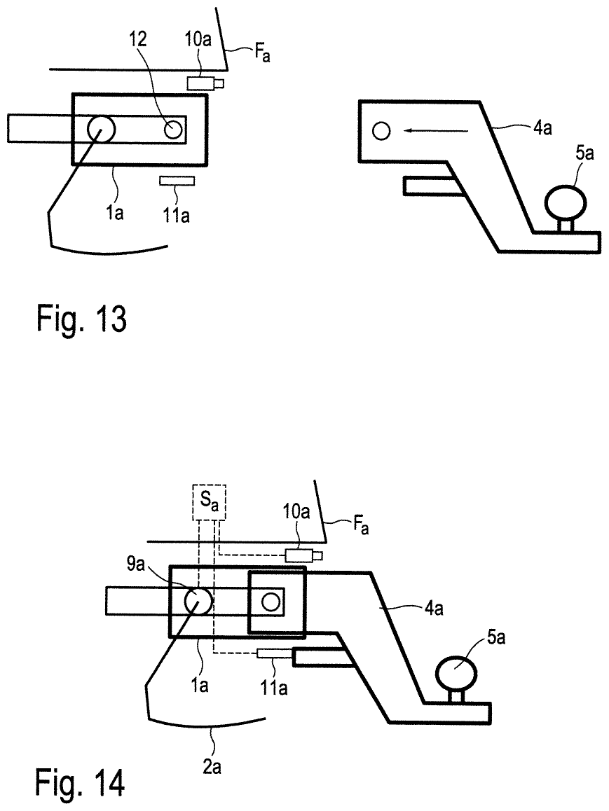

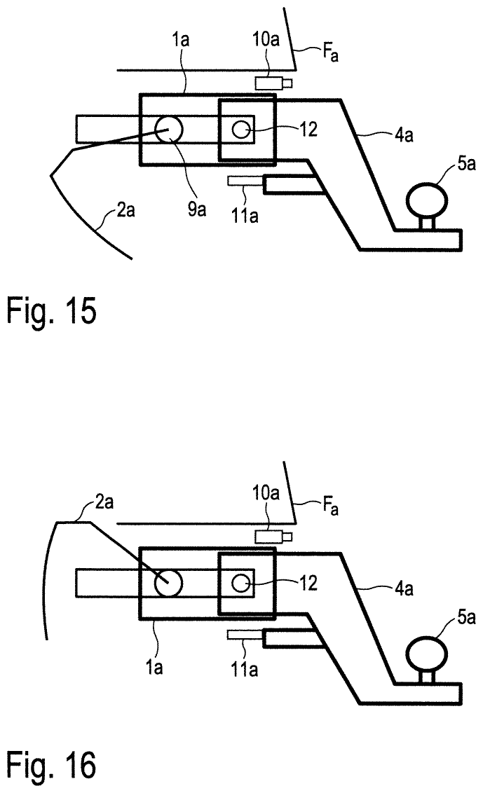

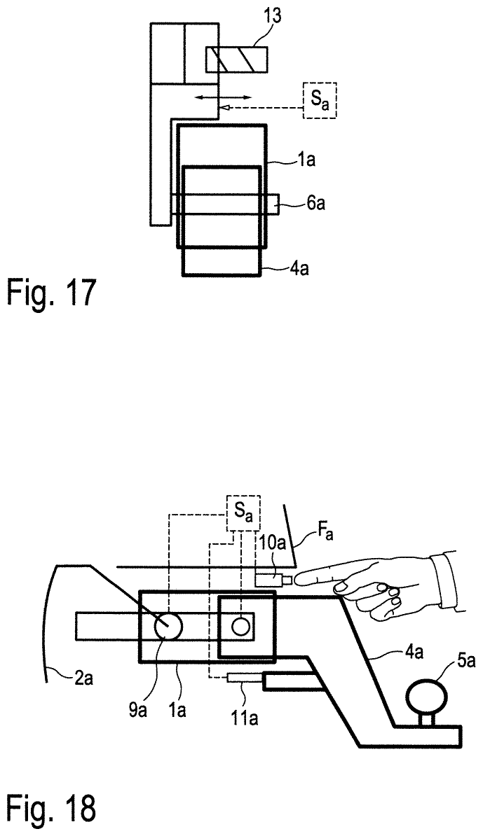

When viewed from the rear behind the cover element 2a, a switching arrangement 10a is positioned within the cut-out in the rear bodywork enclosure so as to be fixed to the vehicle. The switching arrangement 10a is connected to the pivot drive 9a via a control unit Sₐ. By manually actuating the switching arrangement 10a (FIG. 11), the cover element 2a is pivoted into an intermediate position (FIG. 12) in which an open, rear end face of the receptacle la is exposed. A trailer coupling having a gooseneck-like carrier section 4a and a hitch ball 5a can then be inserted into the receptacle 1a, as is apparent on the basis of FIGS. 13 and 14. A sensor arrangement 11a mounted so as to be fixed to the vehicle is assigned to the receptacle 1a. When inserting the carrier section 4a, the sensor arrangement 11a detects the inserted end position and emits a corresponding signal to the control unit Sₐ that the carrier section 4a has reached its inserted functional position. Said control unit in turn actuates the pivot drive 9a on the basis of the sensor signal from the sensor arrangement 11a such that the pivot drive 9a transfers the cover element 2a into its open end position (FIGS. 15 and 16). A forced guide of the locking device 6a, which comprises a securing bolt as a locking element, similarly to the above-described embodiment, projects into the movement path of the cover element 2a between the intermediate position and the open end position. The pivoting mechanism of the cover element 2a is mechanically coupled to this forced guide, such that, when the cover element 2a pivots out of the intermediate position into the open end position, the forced guide is mechanically forced into the securing position of its locking element, as shown in FIG. 17. A return spring 13 automatically pushes the forced guide back in the direction of the release position of the locking device 6a once the cover element 2a has pivoted out of the open end position back in the direction of the intermediate position and the closed position. In the view according to FIG. 18, the cover element 2a is shifted into the open end position and the carrier section 4a is secured in the receptacle la by the locking element of the locking device 6a, which element is constructed as a securing bolt. So that the carrier section 4a together with its hitch ball 5a can then be removed again, the switching arrangement 10a is actuated manually (FIG. 18) again, as a result of which the control unit Sₐ pivots the cover element 2a out of the open end position back in the direction of the intermediate position. As a result, the locking element of the locking device 6a is released from the receptacle 1a by means of the forced guide, such that the carrier section 4a together with its hitch ball 5a can be pulled out of the receptacle la by hand. The sensor arrangement 11a detects the dismounting, i.e. the absence of the carrier section 4a, and sends a corresponding signal to the control unit Sₐ, as a result of which it actuates the pivot drive 9a such that the cover element 2a is pivoted backward out of the open end position or out of the intermediate position back into the closed position, in which the cover element 2a closes the cut-out in the rear bodywork enclosure of the passenger car Fₐ.

1. A motor vehicle comprising a trailer hitch device, the trailer hitch device comprising a rear receptacle fixed to the vehicle and a carrier section for a hitch ball of a trailer coupling, the carrier section being detachably fastened to the receptacle, and comprising a locking element for securing the carrier section to the receptacle, wherein, on a vehicle side, a cover apparatus is provided for covering or exposing the receptacle depending on a fastening of the carrier section, the fastening comprising a cover element mounted on the vehicle side so as to be movable between a closed position and an exposing position, and comprising a drive apparatus connected to the cover element for shifting the cover element.

2. The motor vehicle according to claim 1, further comprising a switching arrangement for activating the drive apparatus.

3. The motor vehicle according to claim 1, further comprising a rear bodywork enclosure having a cut-out in a region of the receptacle, and the cover element is dimensioned such that the cover element is flush with edges of the cut-out in the closed position.

4. The motor vehicle according to claim 3, wherein the drive apparatus comprises a guide arrangement for the cover element, which guide arrangement is disposed on an inside of the rear bodywork enclosure in order to make it possible to shift the cover element on the inside along the rear bodywork enclosure out of the closed position in the direction of the exposing position.

5. The motor vehicle according to claim 1, wherein the drive apparatus comprises pivoting kinematics, in order to shift the cover element between the closed position and the exposing position.

6. A motor vehicle comprising a trailer hitch device, the trailer hitch device comprising a rear receptacle fixed to the vehicle and a carrier section for a hitch ball of a trailer coupling, the carrier section for being detachably fastened to the receptacle, and comprising a locking element for securing the carrier section to the receptacle, wherein the locking element is mounted so as to be movable by a guide apparatus between a securing position blocking the carrier section in the receptacle and an open position that exposes the receptacle.

7. The motor vehicle according to claim 6, the trailer hitch device comprising that a control apparatus assigned to the locking element to shift the locking element between end positions by the guide apparatus.

8. The motor vehicle according to claim 7, further comprising a sensor arrangement, configured to detect the carrier section being mounted on or dismounted from the receptacle, the Sensor arrangement being assigned to the receptacle fixed to the vehicle, and the control apparatus moves the locking element into the securing position or the open position depending on detection signals from the sensor arrangement.

9. The motor vehicle according to claim 8, wherein the drive apparatus is operatively connected to the sensor arrangement in order to shift the cover element, and in that the drive apparatus is coupled to the control apparatus for shifting of the locking element.

10. The motor vehicle according to claim 9, wherein the drive apparatus is coupled to the control apparatus such that the drive apparatus shifts the cover element out of an intermediate position into an end position depending on detection signals from the sensor arrangement, and the drive apparatus interacts with the control apparatus of the locking element when being transferred into the end position in order to activate the control apparatus for shifting the locking element out of the open position into the securing position.

11. The motor vehicle according to claim 10, wherein the drive apparatus mechanically interacts with the control apparatus.

12. A trailer hitch device for a motor vehicle, comprising a rear receptacle fixed to the vehicle and a carrier section for a hitch ball of a trailer coupling, the carrier section being detachably fastened to the receptacle, and comprising a locking element for securing the carrier section to the receptacle, wherein, on a vehicle side, a cover apparatus is provided for covering or exposing the receptacle depending on a fastening of the carrier section, the fastening comprising a cover element mounted so as to be movable on the vehicle side between a closed position and an exposing position, and comprising a drive apparatus connected to the cover element for shifting the cover element, and/or the locking element is mounted so as to be movable by a guide apparatus between a securing position blocking the carrier section in the receptacle and an open position that exposes the receptacle, and a control apparatus is assigned to the locking element in order to shift the locking element between end positions by the guide apparatus.
